(19) United States
(12) Patent Application Publication
(10) Pub. No.: US 2011/0174153 A1
(43) Pub. Date: Jul. 21, 2011

(54) PISTON FOR AN INTERNAL COMBUSTION ENGINE

(75) Inventors: Thomas Hettich, Schwieberdingen (DE); Peter Kleinle, Freiberg am Neckar (DE); Michael Marquardt, Welzheim (DE)

(73) Assignee: MAHLE INTERNATIONAL GMBH, Stuttgart (DE)

(21) Appl. No.: 12/737,751

(22) PCT Filed: Aug. 12, 2009
(86) PCT No.: PCT/DE2009/001119

§ 371 Date: Mar. 16, 2011

(30) Foreign Application Priority Data
Aug. 13, 2008 (DE) 10 2008 038 931.5
Jul. 8, 2009 (DE) 10 2009 032 379.1

(51) Int. Cl. F16J 1/02

(52) U.S. Cl. 92/172

(57) ABSTRACT

The invention proposes a piston (10) for an internal combustion engine, having a piston crown (11), having a fire land (12), having an encircling ring section (13) which has annular grooves (14), and having a piston shank (15) which has two shank walls (16, 17) arranged on the pressure side (DS) and on the counterpressure side (GDS) and two box walls (18, 19) which connect the shank walls (16, 17) to one another, wherein the box walls (18, 19) are provided with pin hubs (21) which have hub bores (22), and wherein the shank wall (16) arranged on the pressure side (DS) is shorter, as viewed in the circumferential direction of the piston (10), than the shank wall (17) arranged on the counterpressure side (GDS). To reduce the loading of the piston, the pressure-side box walls (18) run rectilinearly and obliquely, wherein the spacing of the box walls (18) is greater in the region of the pin hubs (21) than in the region of the pressure-side shank wall (16).

The invention relates to a piston for an internal combustion engine, having a piston crown, having a top land, having a circumferential ring belt that has ring grooves, and having a piston skirt that has two skirt walls disposed on the major thrust side and the minor thrust side, and two box walls that connect the skirt walls with one another, whereby the box walls are provided with pin bosses that have pin bores, and whereby the skirt wall disposed on the major thrust side is shorter, viewed in the circumference direction of the piston, than the skirt wall disposed on the minor thrust side.

In the case of a piston of the type stated initially, the slant position of a connecting rod under ignition pressure brings about a lateral force stress that is given off to the cylinder wall by way of the box walls and the skirt. Furthermore, the ignition pressure, in combination with axial offset or eccentricity of the pin bores, leads to a tipping moment that increases the lateral force stress. The two mechanisms cause great stress on the piston in the lower region, close to the free edge of the skirt/box wall connection, which edge faces away from the piston crown. In the case of unrestricted crank assemblies, the greatest stress is found during or shortly after the pressure maximum on the major thrust side of the piston. In this regard, the skirt/box wall connection on the minor thrust side of the piston is subject to comparatively low stress. In the case of crank assemblies that are restricted toward the major thrust side, the stress on the minor thrust side skirt/box wall connection increases, in comparison.

Accordingly, it is the task of the present invention to reduce the stress on the region of the major thrust side and minor thrust side skirt/box wall connection, which region is subject to great stress and faces away from the piston crown.

This task is accomplished in that the major thrust side box walls run in a straight line and at a slant, whereby the distance of the box walls, in the region of the pin bosses, is greater than in the region of the major thrust side skirt wall.

In advantageous embodiments of the invention, the thickness of the major thrust side box walls can increase, proceeding from the pin boss, in the direction of the skirt wall, and the thickness of the box walls can decrease, proceeding from their free edges, facing away from the piston crown, in the direction of the piston crown, thereby resulting in a further reduction in the stress on the region of the major thrust side and minor thrust side skirt/box wall connection, which region is subject to great stress and faces away from the piston crown.

It can be explained using a simple beam model how the lateral force stress is carried away from the skirt/box wall connection, whereby the skirt wall and the box wall are represented as flat support structures. In this connection, the lateral force stress is introduced in concentrated form close to the free edge of the skirt/box wall connection.

In this connection, it has been shown that ideally straight box walls having the greatest possible slant position, which are connected at the outer boss edge, are subject to the least stress if the load attack point of the resultant lateral force is chosen in realistic manner. In this connection, the slant position of the box walls is mainly limited by the skirt wall width, which must be great enough so that the piston can be reliably guided by way of the skirt. For this reason, the box walls are configured to have a straight line in the region of the lower edge, and set at a slant. In order to achieve a great slant position, the box walls are connected at the outer boss edge.

In order to put homogeneous stress on the structure in the lower region of the skirt/box wall connection, the wall thicknesses must be designed in accordance with the stress. In this way, it is simultaneously guaranteed that unnecessary rigidity on the strength side disappears, and that weight can be saved.

For this reason, the box wall thickness continuously increases, proceeding from the boss, in the direction of the skirt wall, while the skirt wall thickness decreases, proceeding from the end that faces away from the piston crown, in the direction of the piston crown. Furthermore, the increase in thickness of the box wall is implemented in that the inside contour of the box wall is set at a greater slant than its outside contour. As a positive side-effect of this, a slight increase in the box wall slant position is obtained.

Since the skirt/box wall connection experiences great lateral force stress only in its lower region, its thickness is reduced only to the center of the pin bore, in order to keep the piston weight low.

The skirt/box wall connection according to the invention, as described above, should generally be carried out on the major thrust side. If there is supposed to be greater stress on the minor thrust side than on the major thrust side, because of a restricted crank assembly, the design principle is applied to the minor thrust side. The side of the skirt/box wall connection that is subject to less stress is then structured like the one designated as the minor thrust side in the German patent application 10 2007 020 447.9.

An exemplary embodiment of the present invention will be explained in greater detail in the following, using the figures. These show:

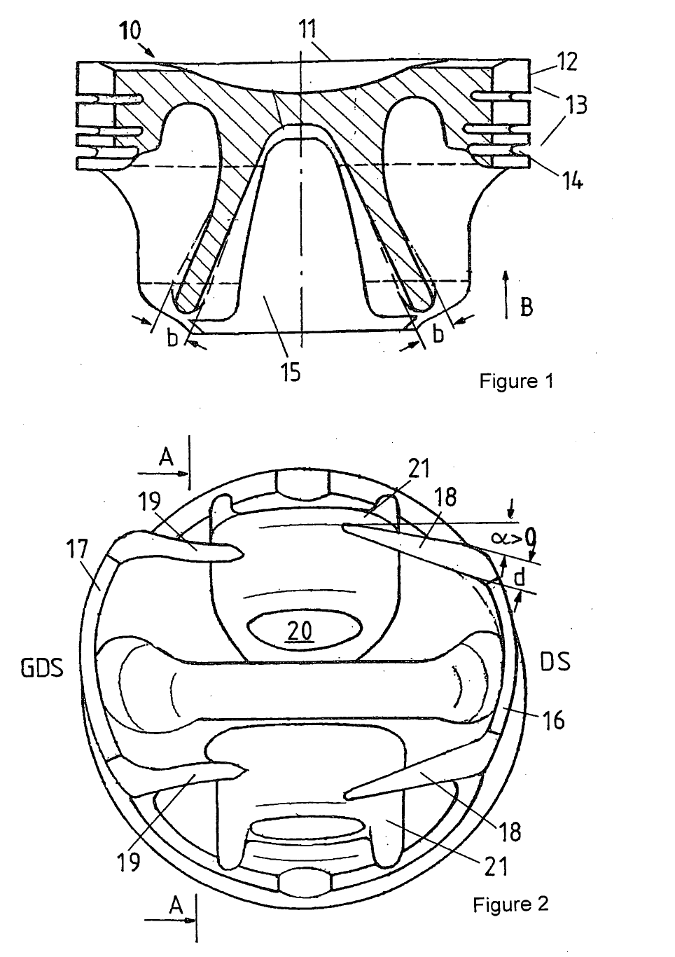

FIG. 1 an embodiment of the piston according to the invention, in section A-A in FIG. 2, and

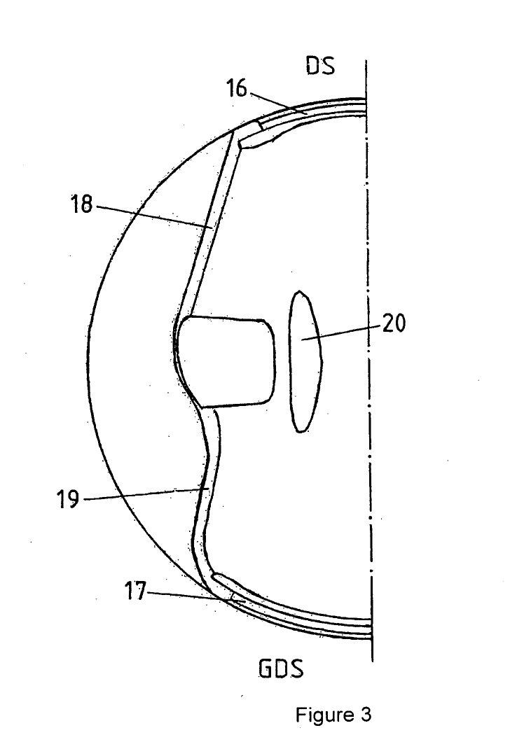

FIGS. 2 and 3 a piston according to FIG. 1 in a bottom view, in the direction of the arrow B in FIG. 1, tilted by a few degrees of angle.

FIGS. 1 to 3 show an exemplary embodiment of the piston 10 according to the invention, which is particularly suitable for use in gasoline engines that are subject to great stress. The piston 10 has a piston crown 11 as well as a circumferential top land 12 and a circumferential ring belt 13 having ring grooves 14.

On the side facing away from the piston crown, the piston 10 has a piston skirt 15 that consists of a skirt wall 16 on the major thrust side (DS) and a skirt wall 17 on the minor thrust side (GDS), whereby the skirt walls 16 and 17 are connected with one another by way of box walls 18 and 19. The box walls 18, 19, in each instance, have a pin boss 21, each having a pin bore 20.

In this connection, the skirt wall 16 on the major thrust side (DS) is configured to be shorter, viewed in the circumference direction, than the skirt wall 17 on the minor thrust side (GDS). Thus the skirt walls 16, 17 are configured asymmetrically.

From FIG. 2, it is evident that the major thrust side box walls 18 are configured in a straight line and set at a slant. The slant position is described by the angle α, which can be greater than or equal to zero. In this connection, the result is therefore that the distance of the box walls 18 from one another is greater in the region of the pin bosses 21 than in the region of the major thrust side 16.

Furthermore, the thickness “d” of the major thrust side box walls 18 increases in linear manner, proceeding from the pin boss 21, in the direction of the skirt wall 16, as can be seen in FIG. 2. Furthermore, the thickness “b” of the box walls 18, 19 decreases, proceeding from their free edges on the side facing away from the piston crown, in the direction of the piston crown 11, as is evident from FIG. 1.

### REFERENCE SYMBOL LIST

10 piston
11 piston crown
12 top land
13 ring belt
14 ring groove
15 piston skirt
16 major thrust side skirt wall
17 minor thrust side skirt wall
18 major thrust side box wall
19 minor thrust side box wall
20 pin bore
21 pin boss

1. Piston (10) for an internal combustion engine, having a piston crown (11), having a top land (12), having a circumferential ring belt (13) that has ring grooves (14), and having a piston skirt (15) that has two skirt walls (16, 17) disposed on the major thrust side (DS) and the minor thrust side (GDS), and two box walls (18, 19) that connect the skirt walls (16, 17) with one another, whereby the box walls (18, 19) are provided with pin bosses (21) that have pin bores (20), and whereby the skirt wall (16) disposed on the major thrust side (DS) is shorter, viewed in the circumference direction of the piston (10), than the skirt wall (17) disposed on the minor thrust side (GDS), wherein the major thrust side box walls (18) run in a straight line and at a slant, whereby the distance of the box walls (18), in the region of the pin bosses (21), is greater than in the region of the major thrust side skirt wall (16).

2. Piston according to claim 1, wherein the thickness of the major thrust side box walls (18) increases, in linear manner, proceeding from the pin boss (21), in the direction of the skirt wall (16).

3. Piston according to claim 1, wherein the thickness of the box walls (18, 19) decreases, proceeding from their free edges, facing away from the piston crown, in the direction of the piston crown (11).
